(19) United States
(12) Patent Application Publication
(10) Pub. No.: US 2023/0135736 A1
(43) Pub. Date: May 4, 2023

(54) Carbon Dioxide Gas Phase Reduction Device and Carbon Dioxide Gas Phase Reduction Method

(71) Applicant: Nippon Telegraph and Telephone Corporation, Tokyo (JP)

(72) Inventors: Sayumi Sato, Musashino-shi, Tokyo (JP); Yuya Uzumaki, Musashino-shi, Tokyo (JP); Yoko Ono, Musashino-shi, Tokyo (JP); Takeshi Komatsu, Musashino-shi, Tokyo (JP)

(21) Appl. No.: 17/914,028

(22) PCT Filed: May 11, 2020
(86) PCT No.: PCT/JP2020/018835

§ 371 Date: Sep. 23, 2022

(51) Int. Cl. C25B 9/23; C25B 9/50; C25B 9/65; C25B 9/67; C25B 1/55; C25B 3/21; C25B 3/26

(52) U.S. Cl. CPC C25B 9/23; C25B 1/55; C25B 3/21; C25B 3/26; C25B 9/50; C25B 9/65; C25B 9/67

(57) ABSTRACT

A gas-phase reduction device for carbon dioxide includes: an oxidation chamber containing an oxidation electrode; a reduction chamber to which carbon dioxide is supplied; a gas reduction sheet that has an ion exchange membrane and a reduction electrode laminated together therein and that is disposed between the oxidation chamber and the reduction chamber with the ion exchange membrane facing the oxidation chamber and the reduction electrode facing the reduction chamber; a conducting wire that connects the oxidation electrode and the reduction electrode; and a heat source that surrounds the reduction chamber.

### TECHNICAL FIELD

The present invention relates to a gas-phase reduction device for carbon dioxide and a gas-phase reduction method for carbon dioxide.

### BACKGROUND ART

Conventionally, techniques for reducing carbon dioxide have attracted attention in terms of prevention of global warming and stable energy supply, and have been actively studied in recent years. Examples of the techniques for reducing carbon dioxide include reduction devices using artificial photosynthesis, in which light energy such as sunlight is applied for reduction, and electrolytic decomposition devices, in which electric energy is applied from the outside for reduction.

The artificial photosynthesis is a technique for promoting the water oxidation reaction and the carbon dioxide reduction reaction through light irradiation to an oxidation electrode made of a photocatalyst. The electrolytic reduction of carbon dioxide is a technique for promoting the water oxidation reaction and the carbon dioxide reduction reaction through voltage application between an oxidation electrode and a reduction electrode made of metals. The artificial photosynthesis technique using sunlight and the electrolytic reduction technique using electricity derived from renewable energy have attracted attention as techniques enable recycling of carbon dioxide into hydrocarbons such as carbon monoxide, formic acid, and ethylene, and alcohols such as methanol and ethanol, and have been actively studied in recent years.

As described in Non-Patent Literatures 1 and 2, conventional artificial photosynthesis technique and electrolytic reduction technique for carbon dioxide have been employed a reaction system in which a reduction electrode (Cu) is immersed in an aqueous solution, and carbon dioxide (CO₂) dissolved in the aqueous solution is supplied to the reduction electrode and is then reduced (see FIG. 2 of Non-Patent Literature 1). However, this carbon dioxide reduction method has limitations of dissolution concentration of carbon dioxide in the aqueous solution and a diffusion coefficient of carbon dioxide in the aqueous solution, which leads to a problem the supply of carbon dioxide to the reduction electrode is limited.

To solve this problem, researches are in progress to supply gas-phase carbon dioxide to the reduction electrode with the view of increasing the supply of carbon dioxide to the reduction electrode. In a gas-phase reduction device for carbon dioxide shown in FIG. 1 of Non-Patent Literature 3, using a reactor that has a structure capable of supplying gas-phase carbon dioxide to a reduction electrode allows the supply of carbon dioxide to the reduction electrode to be increased and consequently the carbon dioxide reduction reaction to be promoted.

### CITATION LIST

### Non-Patent Literature

Non-Patent Literature 1: Satoshi Yotsuhashi, et al., “CO2Conversion with Light and Water by GaN Photoelectrode”, Japanese Journal of Applied Physics, 51, 2012, p.02BP07-1-p.02BP07-3

Non-Patent Literature 2: Yoshio Hori, et al., “Formation of Hydrocarbons in the Electrochemical Reduction of Carbone Dioxide at a Copper Electrode in Aqueous Solution”, Journal of the Chemical Society, 85 (8), 1989, p.2309-p.2326

Non-Patent Literature 3: Ichitaro Waki, et al., “Direct Gas-phase CO2 Reduction for Solar Methane Generation Using a Gas Diffusion Electrode with a BiVO4 : Mo and a Cu—In—Se Photoanode”, Chemistry Letter, 47, Jan. 13, 2018, p.436-p.439

### SUMMARY OF THE INVENTION

### Technical Problem

Unfortunately, in the gas-phase reduction device for carbon dioxide disclosed in Non-Patent Literature 3, as carbon dioxide reduction reactions shown in the following Expressions (1) to (4) proceed, liquid products, such as water (H₂O), formic acid (HCOOH), methanol (CH₃OH) , and ethanol (C₂H₅OH), are produced on the reduction electrode, and these liquid products deposit on the surface of the reduction electrode. Consequently, the gas-phase carbon dioxide cannot be supplied directly to the surface of the reduction electrode, and the resulting decrease in supply of carbon dioxide leads to shorter life times of the carbon dioxide reduction reactions.

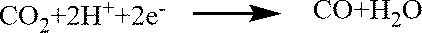

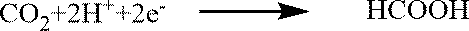

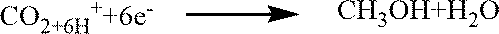

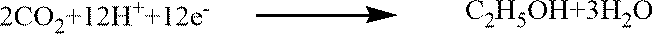

Therefore, a challenge is to maintain the supply of carbon dioxide and improve the life times of the carbon dioxide reduction reactions, through removal of the liquid products produced on the surface of the reduction electrode by the carbon dioxide reduction reactions and constant supply of the gas-phase carbon dioxide directly to the reduction electrode.

When the liquid products deposit on the reduction electrode, the reduction chamber needs to be opened for each recovery of the liquid products and the operation of the device is stopped during the recovery. Therefore, another challenge is to easily recover the liquid products without stopping the device.

The present invention has been made in view of the above circumstances, and an object of the present invention is to improve life times of carbon dioxide reduction reactions in a gas-phase reduction device for carbon dioxide and to provide a technique enabling easy recover of liquid products deposited on a reduction electrode.

### Means for Solving the Problem

A gas-phase reduction device for carbon dioxide according to an aspect of the present invention includes: an oxidation chamber containing an oxidation electrode; a reduction chamber to which carbon dioxide is supplied; a gas reduction sheet that has an ion exchange membrane and a reduction electrode laminated together therein and that is disposed between the oxidation chamber and the reduction chamber with the ion exchange membrane facing the oxidation chamber and the reduction electrode facing the reduction chamber; a conducting wire that connects the oxidation electrode and the reduction electrode; and a heat source that surrounds the reduction chamber.

A gas-phase reduction method for carbon dioxide according to an aspect of the present invention is a gas-phase reduction method for carbon dioxide performed in a gas-phase reduction device for carbon dioxide, the gas-phase reduction device for carbon dioxide including: an oxidation chamber containing an oxidation electrode; a reduction chamber to which carbon dioxide is supplied; a gas reduction sheet that has an ion exchange membrane and a reduction electrode laminated together therein and that is disposed between the oxidation chamber and the reduction chamber with the ion exchange membrane facing the oxidation chamber and the reduction electrode facing the reduction chamber; a conducting wire that connects the oxidation electrode and the reduction electrode; and a heat source that surrounds the reduction chamber, and executing: a first step of pouring an electrolytic solution into the oxidation chamber; a second step of applying heat to the reduction chamber; a third step of flowing the carbon dioxide into the reduction chamber; and a fourth step of irradiating the oxidation electrode with light or applying a voltage between the oxidation electrode and the reduction electrode.

### Effects of the Invention

According to the present invention, the life times of the carbon dioxide reduction reactions can be improved in the gas-phase reduction device for carbon dioxide, and the technique enabling easy recover of the liquid products deposited on the reduction electrode can be provided.

### BRIEF DESCRIPTION OF DRAWINGS

FIG. 1 is a configuration diagram illustrating a configuration of a gas-phase reduction device for carbon dioxide according to Examples 1 to 4.

FIG. 2 illustrates a production method for a gas reduction sheet by electroless plating.

FIG. 3 is a configuration diagram illustrating a configuration of a gas-phase reduction device for carbon dioxide according to Examples 5 to 8.

FIG. 4 is a configuration diagram illustrating a configuration of a conventional gas-phase reduction device for carbon dioxide.

FIG. 5 is a configuration diagram illustrating a configuration of a conventional gas-phase reduction device for carbon dioxide.

### DESCRIPTION OF EMBODIMENTS

Hereinafter, embodiments of the present invention will be described with reference to the drawings. The same components are given the same reference signs throughout the descriptions of drawings, and redundant descriptions of such components are omitted. The present invention is not limited to examples described below and may be variously modified within the gist thereof.

### OUTLINE OF THE INVENTION

The present invention is an invention which relates to a gas-phase reduction device for carbon dioxide that induces carbon dioxide reduction reactions through light irradiation or induces electrolytic carbon dioxide reduction reactions to improve the efficiency of the reduction reactions. The present invention belongs to a technical field with fuel generation technique and a solar energy conversion technique.

The present invention uses a gas reduction sheet obtained by forming a reduction electrode on an ion exchange membrane to supply gas-phase carbon dioxide directly to the surface of the reduction electrode for reduction. In the reduction, liquid products are produced on the surface of the reduction electrode by the carbon dioxide reduction reactions. In the present invention, a heat source is disposed around a reduction chamber, and the reduction electrode is maintained at a temperature equal to or higher than the boiling points of the liquid products with the heat source so that the liquid products are vaporized and removed.

As a result, the liquid products produced on the surface of the reduction electrode can be removed, and the gas-phase carbon dioxide can be constantly supplied directly to the reduction electrode, and thus the life times of the carbon dioxide reduction reactions can be improved. In addition, the vaporization of the liquid products facilitates the recovery of the liquid products.

### Example 1

### Configuration of Gas-Phase Reduction Device for Carbon Dioxide

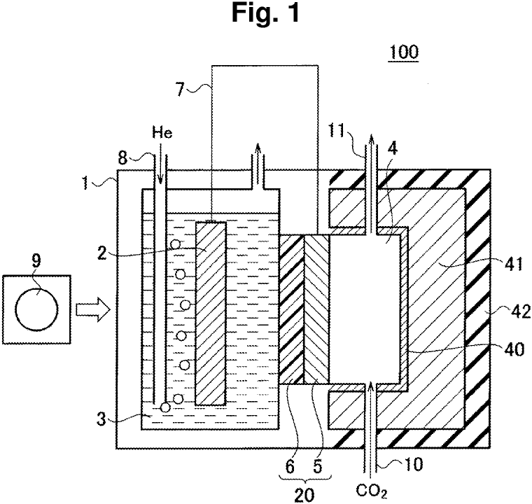

FIG. 1 is a configuration diagram illustrating a configuration of a gas-phase reduction device for carbon dioxide according to Example 1.

A gas-phase reduction device for carbon dioxide 100 includes: an oxidation chamber 1 containing an oxidation electrode 2; a reduction chamber 4 to which carbon dioxide is supplied; a gas reduction sheet 20 that has an ion exchange membrane 6 and a reduction electrode 5 laminated together therein and that is disposed between the oxidation chamber 1 and the reduction chamber 4 with the ion exchange membrane 6 facing the oxidation chamber 1 and the reduction electrode 5 facing the reduction chamber 4; a conducting wire 7 that connects the oxidation electrode 2 and the reduction electrode 5; a heat conductive plate 40, a heat source 41, and a heat insulator 42 that surround the reduction chamber 4; and a light source 9 that irradiates the oxidation electrode 2 with light.

An aqueous solution 3, which is an electrolytic solution, is poured into the oxidation chamber 1. The oxidation electrode 2 in the oxidation chamber 1 is immersed in the aqueous solution 3 poured into the oxidation chamber 1. The oxidation electrode 2 in Example 1 is made of a semiconductor or a metal complex, for example, a nitride semiconductor. The oxidation electrode 2 in Example 1 may have a laminated structure in which different nitride semiconductors are laminated together, or may have another composition such that indium or aluminum is contained. For the oxidation electrode 2 in Example 1, a compound exhibiting photoactivity, such as titanium oxide and amorphous silicon, may be used instead of the nitride semiconductor.

The aqueous solution 3 is an electrolytic solution to be poured into the oxidation chamber 1. The aqueous solution 3 is a potassium hydroxide aqueous solution, for example. The aqueous solution 3 may be, for example, a sodium hydroxide aqueous solution, a potassium chloride aqueous solution, or a sodium chloride aqueous solution, instead of the potassium hydroxide aqueous solution.

The gas reduction sheet 20 has a structure in which the ion exchange membrane 6 and the reduction electrode 5 are laminated together. The ion exchange membrane 6 is, for example, Nafion (R), FORBLUE S-SERIES, or Aquivion, each of which is an electrolyte membrane having a skeleton composed of carbon-fluorine. The reduction electrode 5 is copper, for example. The reduction electrode 5 may be gold, platinum, silver, palladium, gallium, indium, nickel, tin, cadmium, an alloy of these metals, or a mixture of these metals and metal oxides thereof and carbon, instead of copper. The reduction electrode 5 is connected to the oxidation electrode 2 via the conducting wire 7. The gas reduction sheet 20 is disposed between the oxidation chamber 1 and the reduction chamber 4, and the ion exchange membrane 6 is disposed to face the oxidation chamber 1 and the reduction electrode 5 is disposed to face the reduction chamber 4.

The reduction chamber 4 is hollow, and has a gas input port 10 and a gas output port 11 for inflow and outflow of carbon dioxide and the like. The heat source 41 is disposed around the reduction chamber 4. To increase the thermal efficiency of the heat source 41 to the reduction chamber 4, the heat conductive plate 40 is disposed between the reduction chamber 4 and the heat source 41. To prevent heat dissipation from the heat source 41, the heat insulator 42 is disposed to cover the heat source 41. The heat source 41 may be a rubber heater, a hot plate or the like operated by electric power derived from renewable energy or energy derived from fossil fuels, or may use waste heat discharged, for example, from a plant or a waste treatment plant. The heat conductive plate 40 is silver, copper, gold, aluminum, nickel, or platinum, for example.

The light source 9 is provided to operate the gas-phase reduction device for carbon dioxide 100, and is disposed to face the oxidation electrode 2. The light source 9 is a xenon lamp, a pseudo-solar light source, a halogen lamp, a mercury lamp, sunlight, or a combination thereof, for example.

### Production Method for Gas Reduction Sheet

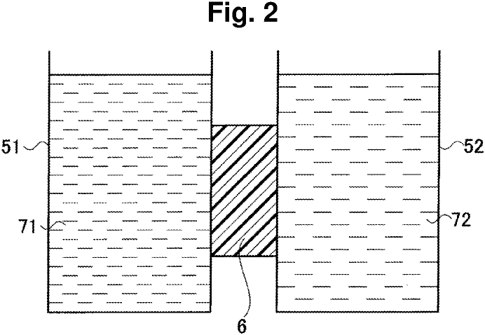

FIG. 2 shows a reaction system of electroless plating used as a production method for the gas reduction sheet 20. Nafion was used for the ion exchange membrane 6, and copper was used for the reduction electrode 5. One surface of the ion exchange membrane 6 is polished, and the ion exchange membrane 6 is immersed in each of boiling nitric acid and boiling pure water. Two chambers 51 and 52 on either side are filled with a plating solution 71 and a reducing agent 72 listed in Table 1, respectively.

TABLE 1

| | | | |
|---|---|---|---|
| Plating Solution | | Reducing Agent | |
| CuSO₄·5H₂O | 3.5 g/L | NaBH₄ | 10 vol% |
| KNaC₄H₄O₆·H₂O | 34.0 g/L | | |
| NaOH | 7.0 g/L | | |
| Na₂CO₃ | 3.0 g/L | | |

The chamber 51 and the chamber 52 are separated by the ion exchange membrane 6. The ion exchange membrane 6 is disposed so that the polished surface faces the plating solution 71. At the interface between the plating solution 71 and the polished surface of the ion exchange membrane 6, the following oxidation-reduction reaction occurs and Copper (Cu) deposits. As a result, the gas reduction sheet 20 having the reduction electrode 5 formed on the ion exchange membrane 6 is obtained.

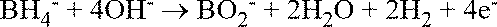

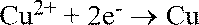

The production method for the gas reduction sheet 20 may be electroplating, physical vapor deposition, or chemical vapor deposition, other than the electroless plating.

### Gas-Phase Reduction Method for Carbon Dioxide

Next, a gas-phase reduction method for carbon dioxide performed in the gas-phase reduction device for carbon dioxide 100 is described. Results of electrochemical measurements and gas/liquid production amount measurements are also described.

### First Step

First, the aqueous solution 3, which is an electrolytic solution, is poured into the oxidation chamber 1, and the oxidation electrode 2 is immersed in the aqueous solution 3. A thin film of n-type gallium nitride (n-GaN), which is an n-type semiconductor, and aluminum gallium nitride (AlGaN) are epitaxially grown on a sapphire substrate in this order, and then vacuum deposition of nickel (Ni) thereon and heat treatment are performed to form a co-catalyst thin film of nickel oxide (NiO). The resultant substrate is used for the oxidation electrode 2. The aqueous solution 3 was 1 mol/L of potassium hydroxide (KOH) aqueous solution. The light irradiation area (light receiving area) of the oxidation electrode 2 was 2.5 cm².

### Second Step

Next, the light source 9 is fixed so that the surface of the oxidation electrode 2 having the oxidation co-catalyst formed thereon and functioning as a semiconductor photoelectrode serves as the irradiation surface. As the light source 9, a 300 W high-pressure xenon lamp (capable of cutting wavelengths of 450 nm or more, and having an illuminance of 6.6 mW/cm²) was used.

### Third Step

Next, the circumference of the reduction chamber 4 is surrounded by the heat conductive plate 40, the heat source 41 is disposed around the heat conductive plate 40, and the circumference of the heat source 41 is further surrounded by the heat insulator 42. To increase the thermal efficiency, they are preferably brought into intimate contact with each other. A copper plate was used for the heat conductive plate 40. A rubber heater was used for the heat source 41. Hard urethane foam was used for the heat insulator 42. The reduction chamber 4 is heated with the heat source 41 so that the temperature near the surface of the reduction electrode 5 reaches 60° C. The temperature near the surface of the reduction electrode 5 can be measured with a thermocouple, for example.

### Fourth Step

Next, helium (He) is flown into the oxidation chamber 1 through a tube 8 and carbon dioxide (CO₂) is flown into the reduction chamber 4 through the gas input port 10, and both gases are at a flow rate of 5 ml/min and a pressure of 0.18 MPa. The gas to be flown into the oxidation chamber 1 may be an inert gas such as argon, nitrogen, and carbon dioxide.

### Fifth Step

Next, after the oxidation chamber 1 and the reduction chamber 4 are sufficiently filled with helium and carbon dioxide, respectively, the oxidation electrode 2 is uniformly irradiated with light using the light source 9. Through the light irradiation, electricity flows between the oxidation electrode 2 and the reduction electrode 5. The water oxidation reaction occurs on the surface of the oxidation electrode 2, and the carbon dioxide reduction reactions proceed at the three-phase interface composed of [the ion exchange membrane 6 — the reduction electrode 5 (copper) — gas phase carbon dioxide] in the gas reduction sheet 20. During the reactions, liquid products such as water (H₂O), formic acid (HCOOH), methanol (CH₃OH) , and ethanol (C₂H₅OH) deposit on the surface of the reduction electrode 5. However, heating the reduction chamber 4 with the heat source 41 allows the deposited liquid products to be vaporized and removed from the surface of the reduction electrode 5, and the mixed gas of gas-phase carbon dioxide and the vaporized liquid products to flow out of the gas output port 11.

### Sixth Step

Lastly, the gases in the oxidation chamber 1 and the reduction chamber 4 are sampled at arbitrary timings during the light irradiation, and the reaction products are analyzed with a gas chromatograph and a gas chromatograph mass spectrometer. The analysis results of the reaction products showed that, in the oxidation chamber 1, oxygen was produced by the water oxidation reaction, and in the reduction chamber 4, hydrogen was produced by the proton reduction reaction, and carbon monoxide, formic acid, methane, methanol, ethanol, and ethylene were produced by the carbon dioxide reduction reactions. The current value between the oxidation electrode 2 and the reduction electrode 5 during the light irradiation were measured with an electrochemical measurement device (1287 type potentiogalvanostat, from Solartron).

### Example 2

In Example 2, the temperature near the surface of the reduction electrode 5 was 100° C. Except this temperature, the method and the configuration of the gas-phase reduction device for carbon dioxide 100 are similar to those in Example 1.

### Example 3

In Example 3, the temperature near the surface of the reduction electrode 5 was 110° C. Except this temperature, the method and the configuration of the gas-phase reduction device for carbon dioxide 100 are similar to those in Example 1.

### Example 4

In Example 4, the temperature near the surface of the reduction electrode 5 was 130° C. Except this temperature, the method and the configuration of the gas-phase reduction device for carbon dioxide 100 are similar to those in Example 1.

### Example 5

### Configuration of Gas-Phase Reduction Device for Carbon Dioxide

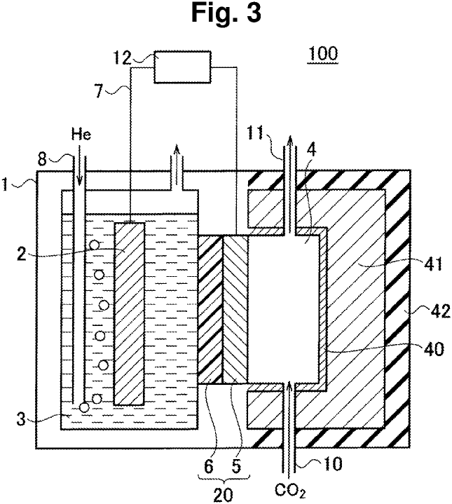

FIG. 3 is a configuration diagram illustrating a configuration of a gas-phase reduction device for carbon dioxide according to Example 5.

In Example 5, a power supply 12 is used instead of the light source 9. The power supply 12 is introduced in the path of the conducting wire 7. The oxidation electrode 2 in Example 5, which is unnecessary to receive light, was made of platinum (from Nilaco). The oxidation electrode 2 in Example 5 may be made of another metal such as gold, silver, copper, indium, and nickel, instead of platinum. The surface area of the oxidation electrode 2 in Example 5 was about 0.55 cm². The configuration of other components is similar to that in Example 1.

### Production Method for Gas Reduction Sheet

The production method for the gas reduction sheet is similar to that in Example 1.

### Gas-Phase Reduction Method for Carbon Dioxide

### First Step

First, the aqueous solution 3, which is an electrolytic solution, is poured into the oxidation chamber 1, and the oxidation electrode 2 (platinum) is immersed in the aqueous solution 3.

### Second Step

Next, the circumference of the reduction chamber 4 is surrounded by the heat conductive plate 40, the heat source 41 is disposed around the heat conductive plate 40, and the circumference of the heat source 41 is further surrounded by the heat insulator 42. Then, the reduction chamber 4 is heated with the heat source 41 so that the temperature near the surface of the reduction electrode 5 reaches 60° C.

### Third Step

Next, helium (He) is flown into the oxidation chamber 1 through the tube 8 and carbon dioxide (CO₂) is flown into the reduction chamber 4 through the gas input port 10, and both gases are at a flow rate of 5 ml/min and a pressure of 0.18 MPa.

### Fourth Step

Next, after the oxidation chamber 1 and the reduction chamber 4 are sufficiently filled with helium and carbon dioxide, respectively, the power supply 12 is connected between the oxidation electrode 2 and the reduction electrode 5 via the conducting wire 7, and a voltage of 1.5 V is applied.

### Fifth Step

Lastly, the gases in the oxidation chamber 1 and the reduction chamber 4 are sampled at arbitrary timings during the light irradiation, and the reaction products are analyzed with a gas chromatograph and a gas chromatograph mass spectrometer.

### Example 6

In Example 6, the temperature near the surface of the reduction electrode 5 was 100° C. Except this temperature, the method and the configuration of the gas-phase reduction device for carbon dioxide 100 are similar to those in Example 5.

### Example 7

In Example 7, the temperature near the surface of the reduction electrode 5 was 110° C. Except this temperature, the method and the configuration of the gas-phase reduction device for carbon dioxide 100 are similar to those in Example 5.

### Example 8

In Example 8, the temperature near the surface of the reduction electrode 5 was 130° C. Except this temperature, the method and the configuration of the gas-phase reduction device for carbon dioxide 100 are similar to those in Example 5.

### Effects of Examples 1 to 8

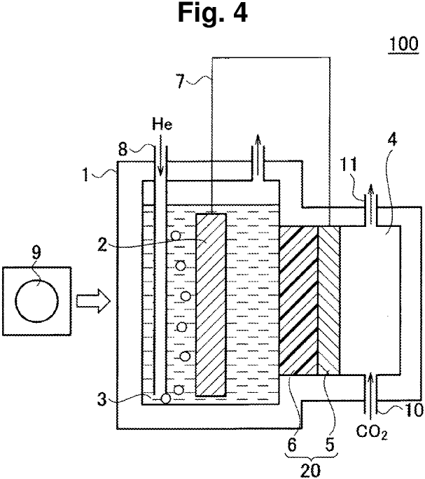

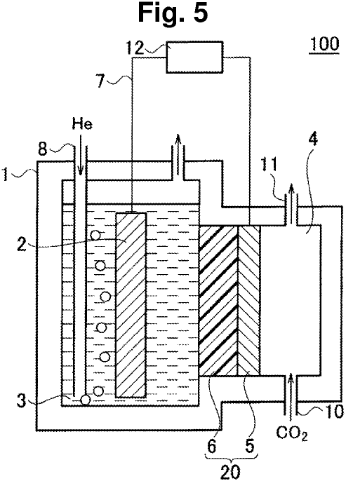

The effects of Examples 1 to 8 are described and compared with those of conventional configurations. FIG. 4 is a conventional configuration corresponding to that in Examples 1 to 4 (FIG. 1), which is referred to as Comparative Example 1. FIG. 5 is a conventional configuration corresponding to that in Examples 5 to 8 (FIG. 3), which is referred to as Comparative Example 2. Comparative Examples 1 and 2 both do not have the heat conductive plate 40, the heat source 41, and the heat insulator 42 disposed around the reduction chamber 4.

Table 2 shows the Faraday efficiency of carbon dioxide reduction reactions 10 minutes after the light irradiation or the voltage application in Examples 1 to 10 and Comparative Examples 1 and 2.

TABLE 2

| | Temperature near Surface of Reduction Electrode (°C) | Faraday Efficiency of Carbon Dioxide Reduction Reactions 10 Minutes after Light Irradiation or Voltage Application (%) |
|---|---|---|
| Example 1 | 60 | 22 |
| Example 2 | 100 | 23 |
| Example 3 | 110 | 22 |
| Example 4 | 130 | 0 |
| Example 5 | 60 | 18 |
| Example 6 | 100 | 17 |
| Example 7 | 110 | 17 |
| Example 8 | 130 | 0 |
| Comparative Example 1 | 25 (Room Temperature) | 22 |
| Comparative Example 2 | 25 (Room Temperature) | 17 |

As shown in Expression (5), the Faraday efficiency means the ratio of a current value used for each reduction reaction to a current value between the electrodes during the light irradiation or the voltage application.

Faraday Efficiency of Each Reduction Reaction = (Current Value for Each Reduction Reaction) / (Current Value between Oxidation Electrode and Reduction Electrode) ... (5)

The “current value for each reduction reaction” in Expression (1) can be calculated by converting the measurement value of the production amount of each reduction product into the number of electrons required for the production reaction thereof. For example, assuming that the concentration of the reduction reaction product is A [ppm], the flow rate of the carrier gas is B [L/sec], the number of electrons required for the reduction reaction is Z [mol], the Faraday constant is F [C/mol], and the molar volume of the gas is Vm [L/mol], the “current value for each reduction reaction” can be calculated using Expression (6). [0056] Current Value for Each Reduction Reaction [A] = (A x B x Z x F x 10-⁶) /Vm... (6)

From Table 2, the Faraday efficiencies in Examples 1 to 3 and Comparative Example 1 are almost the same value, and the Faraday efficiencies in Examples 5 to 7 and Comparative Example 2 are also almost the same value. The reason is considered that the amounts of liquid products deposited on the surface of the reduction electrode 5 are infinitesimal 10 minutes after the light irradiation or the voltage application, and thus the reaction surface is not lost.

On the other hand, in Example 4 and Example 8, the Faraday efficiencies were 0%. The reason is considered that the temperature of as high as 130° C. near the surface of the reduction electrode 5 caused sulfonic acid groups composing the ion exchange membrane to decompose and thus the ion exchange membrane to lose the ion exchange functionality.

From the above, the preferable temperature near the surface of the reduction electrode 5 is considered to be lower than 130° C. The available temperatures for Nafion and FORBLUE S-SERIES mentioned as examples of the ion exchange membrane 6 are 110° C. and the available temperature for Aquivion is 140° C., and therefore they are necessary to be used at these temperatures or lower.

Table 3 shows the maintenance rates of the Faraday efficiency of carbon dioxide reduction reactions 20 hours after the light irradiation or the voltage application in Examples 1 to 3, 5 to 7 and Comparative Examples 1 and 2.

TABLE 3

| | Temperature near Surface of Reduction Electrode (°C) | Maintenance Rate of Faraday Efficiency of Carbon Dioxide Reduction Reactions 20 Hours after Light Irradiation or Voltage Application (%) |
|---|---|---|
| Example 1 | 60 | 43 |
| Example 2 | 100 | 81 |
| Example 3 | 110 | 85 |
| Example 5 | 60 | 48 |
| Example 6 | 100 | 84 |
| Example 7 | 110 | 87 |
| Comparative Example 1 | 25(Room Temperature) | 43 |
| Comparative Example 2 | 25(Room Temperature) | 47 |

As shown in Expression (7), the maintenance rate of the Faraday efficiency of carbon dioxide reduction reactions was defined as the ratio of a Faraday efficiency of carbon dioxide reduction reactions after 20 hours to a Faraday efficiency of carbon dioxide reduction reactions after 10 minutes.

Maintenance Rate of Faraday Efficiency of Carbon dioxide Reduction Reactions = (Faraday Efficiency of Carbon Dioxide Reduction Reactions after 20 Hours) / (Faraday Efficiency of Carbon Dioxide Reduction Reactions after 10 Minutes) ... (7)

From Table 3, the maintenance rates of the Faraday efficiency of carbon dioxide reduction reactions in Examples 2 and 3 and Examples 6 and 7 are each higher than those in Comparative Example 1 and Comparative Example 2, which indicates that the life times of the carbon dioxide reduction reactions were improved. The factor is considered that the constant supply of gas-phase carbon dioxide was achieved to the surface of the reduction electrode 5 for the reason described below. In Example 3 and Example 7, the temperature of 110° C. near the surface of the reduction electrode 5 allowed all the liquid products deposited on the reduction electrode 5, that is, water (boiling point 100° C.) , formic acid (boiling point 100.8° C.), methanol (boiling point 64.7° C.), and ethanol (boiling point 78.37), to be vaporized. In Example 2 and Example 6, the temperature of 100° C. near the surface of the reduction electrode 5 allowed water, methanol, and ethanol to be vaporized and removed from the surface of the reduction electrode 5. The reason the maintenance rates of the Faraday efficiency of carbon dioxide reduction reactions in Example 3 and Example 7 are higher than those in Example 2 and Example 6 is considered that formic acid vaporized.

The maintenance rates of the Faraday efficiency of carbon dioxide reduction reactions in Example 1 and Examples 5 are similar to those in Comparative Example 1 and Comparative Example 2 and lower than those in Examples 2 and 3 and Examples 6 and 7. The reason is considered that the temperature near the surface of the reduction electrode 5 was lower than the boiling points of water, formic acid, methanol, and ethanol and the liquid products deposited on the reduction electrode 5 were not removed, and thus the reaction field on the surface of the reduction electrode 5 was lost. Therefore, the temperature near the surface of the reduction electrode 5 is preferably higher than the boiling points of all the liquid products. In other words, the heating temperature with the heat source 41 is preferably higher than the boiling points of all the liquid products to be produced on the surface of the reduction electrode 5 by the carbon dioxide reduction reactions induced on the surface of the reduction electrode 5.

### EFFECTS OF THE INVENTION

According to the present invention, the gas-phase reduction device for carbon dioxide 100 uses the heat source 41 disposed to surround the reduction chamber 4 to heat liquid products produced on the surface of the reduction electrode 5 by the carbon dioxide reduction reactions, and the liquid products can be thereby vaporized and removed from the surface of the reduction electrode 5. As a result, the gas-phase carbon dioxide can be constantly supplied directly to the reduction electrode 5 and the supply of carbon dioxide can be maintained, which can improve the life times of the carbon dioxide reduction reactions. Further, the vaporization of the liquid products allows all the reduction products to be recovered together in gaseous form, and facilitates the recovery of the liquid products produced on the surface of the reduction electrode 5.

Reference Signs List
1 Oxidation chamber
2 Oxidation electrode
3 Aqueous solution
4 Reduction chamber
5 Reduction electrode
6 Ion exchange membrane
7 Conducting wire
8 Tube
9 Light source
10 Gas input port
11 Gas output port
12 Power supply
20 Gas reduction sheet
40 Heat conductive plate
41 Heat source
42 Heat insulator
51 Chamber
52 Chamber
71 Plating solution
72 Reducing agent 100 Gas-phase reduction device for carbon dioxide

1. A gas-phase reduction device for carbon dioxide, comprising:
an oxidation chamber containing an oxidation electrode;
a reduction chamber to which carbon dioxide is supplied;
a gas reduction sheet that has an ion exchange membrane and a reduction electrode laminated together therein and that is disposed between the oxidation chamber and the reduction chamber with the ion exchange membrane facing the oxidation chamber and the reduction electrode facing the reduction chamber;
a conducting wire that connects the oxidation electrode and the reduction electrode; and
a heat source that surrounds the reduction chamber.

2. The gas-phase reduction device for carbon dioxide according to claim 1, further comprising a light source that irradiates the oxidation electrode with light.

3. The gas-phase reduction device for carbon dioxide according to claim 1, further comprising a power supply that is connected to the conducting wire.

4. The gas-phase reduction device for carbon dioxide according to claim 1, wherein the oxidation electrode is an n-type semiconductor.

5. The gas-phase reduction device for carbon dioxide according to claim 1, further comprising a heat conductive plate and a heat insulator that surround the reduction chamber.

6. A gas-phase reduction method for carbon dioxide performed in a gas-phase reduction device for carbon dioxide,
the gas-phase reduction device for carbon dioxide comprising:
an oxidation chamber containing an oxidation electrode;
a reduction chamber to which carbon dioxide is supplied;
a gas reduction sheet that has an ion exchange membrane and a reduction electrode laminated together therein and that is disposed between the oxidation chamber and the reduction chamber with the ion exchange membrane facing the oxidation chamber and the reduction electrode facing the reduction chamber;
a conducting wire that connects the oxidation electrode and the reduction electrode; and
a heat source that surrounds the reduction chamber, and
executing:
a first step of pouring an electrolytic solution into the oxidation chamber;
a second step of applying heat to the reduction chamber;
a third step of flowing the carbon dioxide into the reduction chamber; and
a fourth step of irradiating the oxidation electrode with light or applying a voltage between the oxidation electrode and the reduction electrode.

7. The gas-phase reduction method for carbon dioxide according to claim 6, wherein, in the second step, heat is applied that has a temperature higher than boiling points of liquids to be produced on a surface of the reduction electrode by reduction reactions of the carbon dioxide induced on the surface of the reduction electrode.

8. The gas-phase reduction device for carbon dioxide according to claim 2, wherein the oxidation electrode is an n-type semiconductor.

9. The gas-phase reduction device for carbon dioxide according to claim 2, further comprising a heat conductive plate and a heat insulator that surround the reduction chamber.

10. The gas-phase reduction device for carbon dioxide according to claim 3, further comprising a heat conductive plate and a heat insulator that surround the reduction chamber.

11. The gas-phase reduction device for carbon dioxide according to claim 4, further comprising a heat conductive plate and a heat insulator that surround the reduction chamber.
